(19) United States
(12) Patent Application Publication
(10) Pub. No.: US 2026/0190176 A1
(43) Pub. Date: Jul. 2, 2026

(54) METHODS AND APPARATUSES FOR UPLINK POSITIONING

(71) Applicant: LENOVO (BEIJING) LIMITED, Beijing (CN)

(72) Inventors: Jie HU, Beijing (CN); Jing HAN, Beijing (CN); Haiming WANG, Beijing (CN); Lihua YANG, Beijing (CN); Luning LIU, Beijing (CN)

(21) Appl. No.: 19/131,117

(22) PCT Filed: Jan. 12, 2023
(86) PCT No.: PCT/CN2023/071942

§ 371 Date: May 19, 2025

(51) Int. Cl. H04W 76/27; H04L 5/00; H04W 56/00; H04W 64/00; H04W 68/00; H04W 74/0833

(52) U.S. Cl. CPC H04W 76/27; H04L 5/0048; H04W 56/0045; H04W 64/00; H04W 68/00; H04W 74/0833

(57) ABSTRACT

Embodiments of the present application are related to methods and apparatuses for uplink positioning. An embodiment of the present application provides a user equipment including: a transceiver and a processor coupled to the transceiver, wherein the processor is configured to: receive, with the transceiver and from a first base station (BS), a first sounding reference signal (SRS) configuration for radio resource control (RRC) inactive or idle state and a first validity area associated with the first SRS configuration; transmit, with the transceiver, an RRC resume request to a second BS, wherein the RRC resume request includes an inactive radio network temporary identifier allocated by the first BS and a cause value indicating to update SRS configuration and associated validity area; and receive, with the transceiver and from the second BS, an RRC release message or an RRC resume message in response to the RRC resume request.

### TECHNICAL FIELD

The present disclosure generally relates to wireless communications, and especially to methods and apparatuses for uplink (UL) positioning.

### BACKGROUND OF THE INVENTION

In 3rd Generation Partnership Project (3GPP) Release 18 study for UL positioning, it is agreed that sounding reference signal (SRS) positioning validity area for UL positioning in radio resource control (RRC) inactive or idle state can avoid reconfiguration of SRS configuration upon cell reselection and it also considered as feasible from both physical layer and high layer perspectives, which are recommended as a potential enhancement for UL configuration for a user equipment (UE), especially for, e.g., low power high accuracy positioning (LPHAP) UEs.

Meanwhile, the UL positioning contains procedures for e.g., SRS configuration, SRS activation and transmission, SRS measurements and report. In the case that a validity area associated with an SRS configuration is defined, corresponding procedures and signaling need to be considered and enhanced to support the validity area associated with the SRS configuration, including, for example, SRS activation or deactivation within the validity area, timing advance/alignment (TA) update within the validity area, or update of SRS configuration and the associated validity area.

### SUMMARY

Some embodiments of the present disclosure provide a UE including: a transceiver and a processor coupled to the transceiver, wherein the processor is configured to: receive, with the transceiver and from a first base station (BS), a first SRS configuration for RRC inactive or idle state and a first validity area associated with the first SRS configuration; transmit, with the transceiver, an RRC resume request to a second BS, wherein the RRC resume request includes an inactive radio network temporary identifier (I-RNTI) allocated by the first BS and a cause value indicating to update SRS configuration and associated validity area; and receive, with the transceiver and from the second BS, an RRC release message or an RRC resume message in response to the RRC resume request.

In some embodiments, the processor is further configured to: keep the UE in RRC inactive state in the case that the RRC release message includes a suspend indication; move the UE into RRC idle state in the case that the RRC release message includes no suspend indication; or move the UE into RRC connected state in the case that the RRC resume message is received.

In some embodiments, the processor is further configured to receive, with the transceiver and from the second BS, a second SRS configuration for RRC inactive or idle state and a second validity area associated with the second SRS configuration.

In some embodiments, the first SRS configuration is associated with semi-persistent or aperiodic SRS resources, and the processor is further configured to: receive, with the transceiver and from the first BS, a paging message with a paging cause value indicating to activate or deactivate SRS transmission based on the first SRS configuration; and in response to the paging message, activate or deactivate the semi-persistent or aperiodic SRS resources.

In some embodiments, the processor is further configured to transmit, with the transceiver, an RRC resume request for requesting TA configuration in the case that the paging cause value indicates to activate SRS transmission.

In some embodiments, the processor is further configured to transmit, with the transceiver, a TA request for TA configuration update periodically or when at least one of the following conditions is met: the UE reselects to a new cell within the first validity area; a current TA timer expires or the current TA timer will expire after a predefined or configured period of time; a first SRS transmission is performed according to a time domain behavior of a current SRS resource configuration or the first SRS transmission will be performed after a predefined or configured period of time according to the time domain behavior of the current SRS resource configuration; or an SRS configuration update is initiated.

In some embodiments, the processor is configured to transmit the TA request by using at least one of the following: an MSG1 or MSGA message with a dedicated or shared preamble and on dedicated or shared physical random access channel (PRACH) resources pre-configured in a system information block (SIB) message; an RRC resume request with a cause value indicating to update TA configuration; or an uplink message for a small data transmission (SDT) procedure.

In some embodiments, the processor is further configured to receive at least one of a TA command or an updated TA configuration in response to the TA request.

In some embodiments, the processor is further configured to receive at least one of a TA command or an updated TA configuration by using at least one of an MSG2 or MSGB message, a paging message, or a downlink message for an ongoing SDT procedure.

Some embodiments of the present disclosure provide a first BS including: a transceiver and a processor coupled to the transceiver, wherein the processor is configured to: transmit, with the transceiver and to a UE, a first SRS configuration for RRC inactive or idle state and a first validity area associated with the first SRS configuration; receive, with the transceiver and from a second BS, a retrieve context request for retrieving a context of the UE, wherein the retrieve context request includes a cause value indicating to update SRS configuration and associated validity area of the UE; and transmit, with the transceiver and to the second BS, (1) a retrieve context response with the context of the UE in the case that it is determined to update the first SRS configuration and the first validity area, or (2) a retrieve context failure message including an encapsulated RRC release message in the case that it is determined not to update the first SRS configuration and the first validity area.

In some embodiments, the processor is further configured to: transmit, with the transceiver and to a location management function (LMF), an SRS validity area update indication including an identity of the second BS in response to receiving the retrieve context request; and receive, with the transceiver and from the LMF, an SRS validity area update response in response to the SRS validity area update indication, wherein the SRS validity area update response indicates that the LMF acknowledges or rejects to update the first SRS configuration and the first validity area.

In some embodiments, the processor is further configured to: receive, with the transceiver and from the LMF, a first release indication to release SRS resources associated with the first SRS configuration.

In some embodiments, the processor is further configured to transmit, with the transceiver and to other cells within the first validity area, a second release indication to indicate the other cells to release SRS resources associated with the first SRS configuration in response to receiving the first release indication.

In some embodiments, the processor is further configured to transmit, with the transceiver and to other cells within the first validity area, a release indication to indicate the other cells to release SRS resources associated with the first SRS configuration in response to receiving the SRS validity area update response indicating that the LMF acknowledges to update the first SRS configuration and the first validity area.

In some embodiments, the encapsulated RRC release message includes a suspend indication in the case that it is determined to keep the UE to RRC inactive state.

In some embodiments, the encapsulated RRC release message includes no suspend indication, and the processor is further configured to delete the context of the UE in the case that it is determined to move the UE into RRC idle state.

In some embodiments, the first SRS configuration is associated with semi-persistent or aperiodic SRS resources, and the processor is further configured to: receive, with the transceiver and from an LMF, a positioning activation or deactivation request indicating the first BS to activate or deactivate SRS transmission associated with the first SRS configuration; and in response to receiving the positioning activation or deactivation request, transmit, with the transceiver and to the UE, a paging message with a paging cause value indicating to activate or deactivate SRS transmission based on the first SRS configuration.

In some embodiments, in the case that the paging cause value indicates to activate SRS transmission based on the first SRS configuration, the processor is further configured to receive, with the transceiver and from the UE, an RRC resume request for requesting TA configuration.

In some embodiments, the processor is further configured to: inform other cells within the first validity area to reserve the semi-persistent or aperiodic SRS resources in the case that the positioning activation or deactivation request indicates the first BS to activate SRS transmission; or inform other cells within the first validity area to release the semi-persistent or aperiodic SRS resources in the case that the positioning activation or deactivation request indicates the first BS to deactivate SRS transmission.

In some embodiments, the processor is further configured to: receive, with the transceiver and from the UE, a TA request for TA configuration update by using at least one of the following: an MSG1 or MSGA message with a dedicated or shared preamble and on dedicated or shared PRACH resources pre-configured in a SIB message; an RRC resume request with a cause value indicating to update TA configuration; or an uplink message for an SDT procedure; and transmit, with the transceiver and to the UE, at least one of a TA command or an updated TA configuration in response to the TA request.

In some embodiments, the processor is further configured to transmit, with the transceiver and to the UE, at least one of a TA command or an updated TA configuration periodically or when at least one of the following conditions is met: the first BS receives an indication from an LMF indicating to update TA configuration; a current TA timer expires or the current TA timer will expire after a predefined or configured period of time; or a first SRS transmission is performed according to a time domain behavior of a current SRS resource configuration or the first SRS transmission will be performed after a predefined or configured period of time according to the time domain behavior of the current SRS resource configuration.

In some embodiments, the indication is a dedicated indication for TA configuration update or a positioning activation or deactivation request indicating the first BS to activate SRS transmission based on the first SRS configuration.

In some embodiments, the at least one of the TA command or the updated TA configuration is transmitted by using at least one of an MSG2 or MSGB message, a paging message, or a downlink message for an ongoing SDT procedure.

Some embodiments of the present disclosure provide an LMF including: a transceiver and a processor coupled to the transceiver, wherein the processor is configured to: receive, with the transceiver and a first BS, an SRS validity area update indication including an identity of a second BS, wherein the SRS validity area update indication indicates updating a first validity area associated with a first SRS configuration for RRC inactive or idle state for a UE; transmit, with the transceiver, an SRS validity area update response to the first BS in response to the SRS validity area update indication, wherein the SRS validity area update response indicates that the LMF acknowledges or rejects to update the first SRS configuration and the first validity area.

In some embodiments, the processor is further configured to transmit, with the transceiver and to the first BS, a release indication indicating to release SRS resources associated with the first SRS configuration in the case that the LMF acknowledges to update the first SRS configuration and the first validity area.

In some embodiments, the processor is further configured to transmit, with the transceiver, the release indication to other cells within the first validity area.

In some embodiments, in the case that the LMF acknowledges to update the first SRS configuration and the first validity area, the processor is further configured to transmit, with the transceiver, UL SRS transmission characteristics information to the second BS.

In some embodiments, the UL SRS transmission characteristics information indicates a second validity area associated with a second SRS configuration determined by the second BS.

In some embodiments, the first SRS configuration is associated with semi-persistent or aperiodic SRS resources, and the processor is further configured to: transmit, with the transceiver and to the first BS, a positioning activation or deactivation request indicating the first BS to activate or deactivate SRS transmission based on the first SRS configuration.

Some embodiments of the present disclosure provide a second BS including: a transceiver and a processor coupled to the transceiver, wherein the processor is configured to: receive, with the transceiver and from a UE, an RRC resume request including an I-RNTI allocated by a first BS and a cause value indicating to update SRS configuration and associated validity area; in response to receiving the RRC resume request, transmit, with the transceiver and to the first BS, a retrieve context request for retrieving a context of the UE, wherein the retrieve context request includes a cause value indicating to update SRS configuration and associated validity area; receive, with the transceiver and from the first BS, (1) a retrieve context response with the context of the UE or (2) a retrieve context failure message including an encapsulated RRC release message; and transmit, with the transceiver and to the UE, an RRC release message or an RRC resume message based on the received retrieve context response or retrieve context failure message.

In some embodiments, the RRC release message including a suspend indication or the RRC resume message is transmitted and the processor is further configured to transmit, with the transceiver, an updated SRS configuration and an updated associated validity area to the UE, in the case that the retrieve context response is received.

In some embodiments, the processor is further configured to: receive UL SRS transmission characteristics information from an LMF in the case that the retrieve context response is received.

In some embodiments, the UL SRS transmission characteristics information indicates the updated associated validity area.

In some embodiments, the RRC release message including a suspend indication is transmitted in the case that the retrieve context failure message is received and the encapsulated RRC release message includes a suspend indication.

In some embodiments, the RRC release message including no suspend indication is transmitted in the case that the retrieve context failure message is received and the encapsulated RRC release message includes no suspend indication.

Some embodiments of the present disclosure provide a method performed by a UE. The method includes: receiving, from a first BS, a first SRS configuration for RRC inactive or idle state and a first validity area associated with the first SRS configuration; transmitting an RRC resume request to a second BS, wherein the RRC resume request includes an I-RNTI allocated by the first BS and a cause value indicating to update SRS configuration and associated validity area; and receiving, from the second BS, an RRC release message or an RRC resume message in response to the RRC resume request.

Some embodiments of the present disclosure provide a method performed by a first BS. The method includes: transmitting, to a UE, a first SRS configuration for RRC inactive or idle state and a first validity area associated with the first SRS configuration; receiving, from a second BS, a retrieve context request for retrieving a context of the UE, wherein the retrieve context request includes a cause value indicating to update SRS configuration and associated validity area of the UE; and transmitting, to the second BS, (1) a retrieve context response with the context of the UE in the case that it is determined to update the first SRS configuration and the first validity area, or (2) a retrieve context failure message including an encapsulated RRC release message in the case that it is determined not to update the first SRS configuration and the first validity area.

Some embodiments of the present disclosure provide a method performed by an LMF. The method includes: receiving, from a first BS, an SRS validity area update indication including an identity of a second BS, wherein the SRS validity area update indication indicates updating a first validity area associated with a first SRS configuration for RRC inactive or idle state for a UE; and transmitting an SRS validity area update response to the first BS in response to the SRS validity area update indication, wherein the SRS validity area update response indicates that the LMF acknowledges or rejects to update the first SRS configuration and the first validity area.

Some embodiments of the present disclosure provide a method performed by a second BS. The method includes: receiving, from a UE, an RRC resume request including an I-RNTI allocated by a first BS and a cause value indicating to update SRS configuration and associated validity area; in response to receiving the RRC resume request, transmitting, to the first BS, a retrieve context request for retrieving a context of the UE, wherein the retrieve context request includes a cause value indicating to update SRS configuration and associated validity area; receiving, from the first BS, (1) a retrieve context response with the context of the UE or (2) a retrieve context failure message including an encapsulated RRC release message; and transmitting, to the UE, an RRC release message or an RRC resume message based on the received retrieve context response or retrieve context failure message.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present disclosure.

FIG. 2 illustrates a flowchart of an exemplary method for validity area update with UE context relocation according to some embodiments of the present disclosure.

FIG. 3 illustrates a flowchart of an exemplary method for validity area update without UE context relocation according to some embodiments of the present disclosure.

FIG. 4 illustrates a flowchart of an exemplary method for SRS activation or deactivation within an SRS validity area according to some embodiments of the present disclosure.

FIG. 5 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as 3GPP long term evolution (LTE), LTE advanced, 5G new radio (NR), 5G-Advanced, 6G, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

The present disclosure provides various solutions to implement procedures in UL positioning, e.g., procedures for SRS activation or deactivation within a validity area, TA update within a validity area, or update of SRS configuration and the associated validity area.

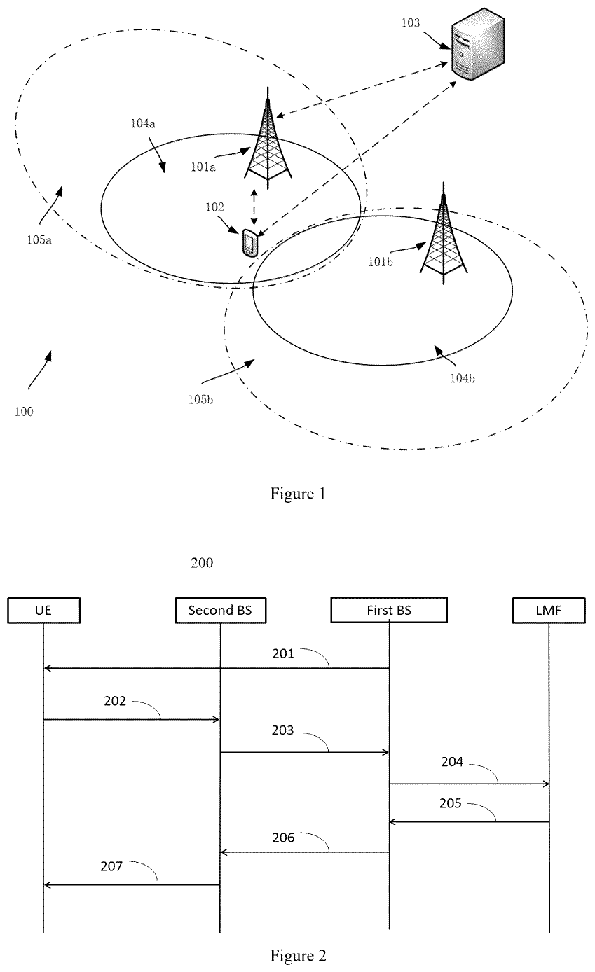

FIG. 1 is a schematic diagram illustrating an exemplary wireless communication system 100 according to some embodiments of the present disclosure.

As shown in FIG. 1, the wireless communication system 100 includes: at least one BS (e.g., BS 101a and BS 101b), at least one UE 102, and at least one LMF 103. Although two BSs, one UE, and one LMF are depicted in FIG. 1 for illustrative purpose, it is contemplated that any number of BSs, UEs, and LMFs may be included in the wireless communication system 100 according to various embodiments of the present disclosure.

The wireless communication system 100 is compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

The BS 101a or BS 101b may also be referred to as an access point, an access terminal, a base, a macro cell, a radio access network (RAN) node, a next generation (NG) RAN node, a node-B, an enhanced or evolved node B (eNB), a generalized node B (gNB), a home node-B, a relay node, or a device, or described using other terminology used in the art. The BS 101a or BS 101b is generally part of a RAN that may include at least one controller communicably coupled to it.

In some embodiments, the BS 101a and the BS 101b may communicate with each other, for example, via Xn interface.

According to some embodiments of the present application, the UE 102 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE. In an embodiment of the present application, the UE 102 may be an LPHAP UE.

According to some other embodiments of the present application, the UE 102 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE 102 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE 102 may include wearable devices, such as smart watches, fitness bands, optical head-mounted displays, or the like.

Moreover, the UE 102 may be referred to as a subscriber unit, a mobile, a mobile station, a user, a terminal, a mobile terminal, a wireless terminal, a fixed terminal, a subscriber station, a user terminal, or a device, or described using other terminology used in the art.

In the example shown in FIG. 1, when the UE 102 is in a coverage area of the BS 101a, the UE 102 may communicate with the BS 101a, for example, via LTE or NR Uu interface. As an example, the UE 102 may camp to a cell 104a of the BS 101a. In some cases, the UE 102 may move and then camp or reselect to another cell, e.g., another cell of the BS 101a or a cell 104b of the BS 101b.

The LMF 103 (also referred to as LMF entity) may refer to a network element or network entity for supporting location services, which may be deployed in a core network (CN) or in a RAN of the wireless communication system 100. The LMF 103 may communicate with the BS 101a and the BS 101b via, e.g., NR positioning protocol A (NRPPa) signaling, and may communicate with the UE 102 via, e.g., LTE positioning protocol (LPP) signaling. In the present disclosure, each of the LMF 103, the BS 101a, or the BS 101b may be referred to as a network entity.

In some embodiment of the present disclosure, the BS 101a may configure or pre-configure an SRS configuration for RRC inactive or idle state for the UE 102. In the case that the UE 102 supports SRS configuration with validity area, the BS 101a may also configure or pre-configure a validity area associated with the SRS configuration. For example, the BS 101a may configure or pre-configure an SRS configuration for RRC inactive or idle state and an associated validity area 105a when the UE 102 camps to the cell 104a, wherein the validity area 105a may consist of at least one cell including the cell 104a. When the UE 102 camps or reselects to another cell within the validity area 105a, it may keep using the SRS configuration associated with the validity area 105a and does not need to perform SRS reconfiguration. When the UE 102 camps or reselects to a new cell (e.g., the cell 104b) out of the validity area 105a, it may request SRS reconfiguration (also referred to as SRS configuration update).

In some embodiments of the present disclosure, a validity area (e.g., the validity area 105a or the validity area 105b) may consist of at least one cell which is a subset of a RAN based notification area (RNA) or CN tracking area or equal to an RNA or CN tracking area. In some other embodiments, a validity area may include one or more specified neighboring cells surrounding a current serving cell or one or more cells within a specific range of the current serving cell. In some other embodiments, a validity area may consist of one or more cells under management of the same LMF. A network (e.g., wireless communication system 100) may provide different validity area definitions to different UEs, but does not mix different validity area definitions to the same UE at the same time.

According to some embodiments of the present disclosure, a UE may trigger update of SRS configuration and associated validity area, e.g., periodically or when the UE moves out of the configured validity area or the SRS configuration becomes invalid (e.g., a current TA timer expires). Such procedures may occur with or without involvement of UE context relocation.

FIG. 2 illustrates a flowchart of an exemplary method 200 for validity area update with UE context relocation according to some embodiments of the present disclosure. The method 200 illustrated in FIG. 2 may be performed by at least four entities, e.g., a UE (e.g., the UE 102), a first BS (e.g., the BS 101a), a second BS (e.g., the BS 101b), and an LMF (e.g., the LMF 103). Although the method is illustrated in a system level, persons skilled in the art can understand that the method implemented in the four entities can be separately implemented and incorporated in other apparatus with the like functions. It is also contemplated that the method 200 may include additional steps not shown.

As shown in FIG. 2, in step 201, the first BS may transmit an SRS configuration for RRC inactive or idle state and a validity area associated with the SRS configuration to the UE. For example, the first BS may transmit the SRS configuration or the validity area via RRC signaling or system information. The first BS may store a context of the UE and allocate an I-RNTI to the UE when moving the UE into RRC inactive state. The I-RNTI is used to identify the context of the UE in RRC inactive state.

In step 202, the UE (in RRC inactive state) may transmit an RRC resume request to the second BS. The RRC resume request may include the allocated I-RNTI and a cause value indicating to update SRS configuration and associated validity area.

After receiving the RRC resume request, the second BS may resolve an identity of the first BS contained in the I-RNTI such that the second BS may determine that the first BS configured the current SRS configuration for RRC inactive or idle state and associated validity area for the UE. Then, in step 203, the second BS may transmit a retrieve context request for retrieving the context of the UE to the first BS, wherein the retrieve context request may include a cause value indicating to update SRS configuration and associated validity area of the UE.

In step 204, the first BS may transmit an SRS validity area update indication to the LMF in response to reception of the retrieve context request, wherein the SRS validity area update indication may include an identity of the second BS and indicate to update SRS configuration for RRC inactive or idle state and associated validity area for the UE. The LMF may determine whether to acknowledge or reject to update the SRS configuration for RRC inactive or idle state and associated validity area in response of reception of the SRS validity area update indication.

The example illustrated in FIG. 2 shows the case that the LMF acknowledges to update the SRS configuration for RRC inactive or idle state and associated validity area. In such case, in step 205, the LMF may transmit an SRS validity area update response to the first BS, wherein the SRS validity area update response indicates that the LMF acknowledges to update SRS configuration for RRC inactive or idle state and associated validity area.

In some embodiments, the LMF may transmit a release indication to the first BS, to indicate the first BS to release SRS resources associated with the current SRS configuration for RRC inactive or idle state of the UE. In an embodiment, the release indication may be included in the SRS validity area update response. In another embodiment, the release indication may be included in another message to the first BS. The first BS may release the SRS resources associated with the current SRS configuration for RRC inactive or idle state of the UE in response to reception of the release indication. In some embodiments of the present disclosure, e.g., in the case that the current validity area associated with the current SRS configuration for RRC inactive or idle state of the UE was determined by the LMF, the LMF may transmit the same release indication to other cells within the current validity area. In some other embodiments of the present disclosure, e.g., in the case that the current validity area associated with the current SRS configuration for RRC inactive or idle state of the UE was determined by the first BS, in response to receiving the release indication from the LMF, the first BS may transmit a release indication to other cells within the current validity area, to indicate the other cells to release SRS resources associated with the current SRS configuration for RRC inactive or idle state of the UE.

In some other embodiments, the LMF may not transmit the release indication to the first BS. In such embodiments, the first BS may release the SRS resources associated with the current SRS configuration for RRC inactive or idle state of the UE in response to reception of the SRS validity area update response indicates that the LMF acknowledges to update SRS configuration for RRC inactive or idle state and associated validity area. In some embodiments of the present disclosure, e.g., in the case that the current validity area associated with the current SRS configuration for RRC inactive or idle state of the UE was determined by the LMF, the LMF may transmit a release indication to other cells within the current validity area, to indicate the other cells to release SRS resources associated with the current SRS configuration for RRC inactive or idle state of the UE. In some other embodiments of the present disclosure, e.g., in the case that the current validity area associated with the current SRS configuration for RRC inactive or idle state of the UE was determined by the first BS, in response to receiving the SRS validity area update response from the LMF, the first BS may transmit a release indication to other cells within the current validity area, to indicate the other cells to release SRS resources associated with the current SRS configuration for RRC inactive or idle state of the UE.

In step 206, in response to reception of the SRS validity area update response indicates that the LMF acknowledges to update SRS configuration for RRC inactive or idle state and associated validity area, the first BS may transmit a retrieve context response with the context of the UE to the second BS.

After transmitting the SRS validity area update response to the first BS, the LMF may transmit UL SRS transmission characteristics information to the second BS. The UL SRS transmission characteristics information transmitted by the LMF is also referred to as “requested UL-SRS transmission characteristics information,” which may indicate characteristics of SRS to be transmitted by the UE for the time period required to perform uplink measurement. In some embodiments, the UL SRS transmission characteristics information may indicate an updated validity area.

After receiving the retrieve context response from the first BS and the UL SRS transmission characteristics information from the LMF, the second BS may determine an updated SRS configuration for RRC inactive or idle state and an updated validity area associated with the update SRS configuration (i.e., updated associated validity area) for the UE. In some embodiments, the second BS may autonomously determine the updated associated validity area. In some other embodiments, the second BS may determine the updated associated validity area based on the UL SRS transmission characteristics information received from the LMF. For example, the updated associated validity area may be the updated validity area indicated by the UL SRS transmission characteristics information.

In some embodiments, in step 207, the second BS may transmit an RRC release message to the UE, wherein the RRC release message includes a suspend indication, which may indicate the UE to keep in RRC inactive state. In response to reception of the RRC release message, the UE may be kept in RRC inactive state. Furthermore, the second BS may transmit the updated SRS configuration for RRC inactive or idle state and the updated associated validity area to the UE in step 207. The updated SRS configuration or the updated associated validity area may be transmitted via the RRC release message or system information.

In some embodiments, in step 207, the second BS may transmit an RRC resume message to the UE, wherein the RRC resume message may indicate the UE to move to RRC connected state. In response to reception of the RRC resume message, the UE may enter in RRC connected state and transmit an RRC resume complete message to the second BS. The updated SRS configuration or the updated associated validity area may be transmitted via an RRC message when the UE is in RRC connected state.

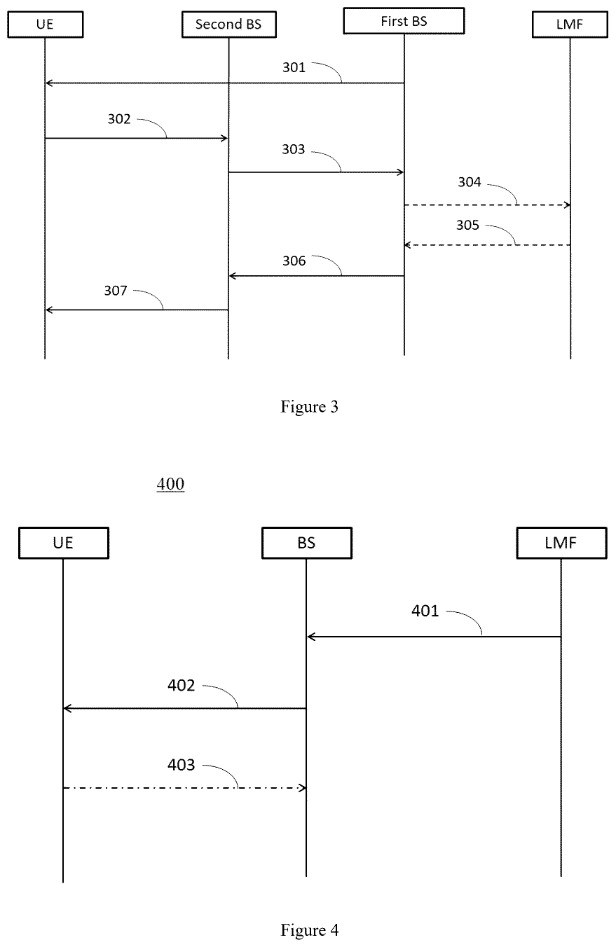

FIG. 3 illustrates a flowchart of an exemplary method 300 for validity area update without UE context relocation according to some embodiments of the present disclosure. The method 300 illustrated in FIG. 3 may be performed by at least four entities, e.g., a UE (e.g., the UE 102), a first BS (e.g., the BS 101a), a second BS (e.g., the BS 101b), and an LMF (e.g., the LMF 103). Although the method is illustrated in a system level, persons skilled in the art can understand that the method implemented in the four entities can be separately implemented and incorporated in other apparatus with the like functions. It is also contemplated that the method 300 may include additional steps not shown.

Steps 301, 302, 303, and 304 may be the same as steps 201, 202, 203, and 204 illustrated in FIG. 2. Details of steps 301, 302, 303, and 304 are omitted herein for purpose of simplicity and clarity.

The example illustrated in FIG. 3 shows the case that the LMF rejects to update the SRS configuration for RRC inactive or idle state and associated validity area. Such case may occur when, for example, the UE is still within the validity area associated with the current SRS configuration for RRC inactive or idle state. In such case, in step 305, the LMF may transmit an SRS validity area update response to the first BS, wherein the SRS validity area update response may indicate that the LMF rejects to update SRS configuration for RRC inactive or idle state and associated validity area.

In some embodiments of the present disclosure, after receiving the retrieve context request from the second BS, the first BS itself may determine not to update SRS configuration for RRC inactive or idle state and associated validity area of the UE. In such embodiments, steps 304 and 305 can be omitted.

In response to receiving the SRS validity area update response indicating that the LMF rejects to update SRS configuration for RRC inactive or idle state and associated validity area or determining not to update SRS configuration for RRC inactive or idle state and associated validity area, the first BS may store some information included in the retrieve context request received from the second BS, e.g., Cell-Radio Network Temporary Identifier (C-RNTI) and Physical Cell Identifier (PCI) related to the second BS, for the next resume attempt from the UE. Furthermore, in step 306, the first BS may transmit a retrieve context failure message to the second BS, wherein the retrieve context failure message may include an encapsulated RRC release message. In some embodiments, the encapsulated RRC release message may include a suspend indication in the case that the first BS determines to keep the UE in RRC inactive state. In some embodiments, the encapsulated RRC release message may include no suspend indication in the case that the first BS determines to move the UE into RRC idle state. Furthermore, the first BS may delete the context of the UE in the case that it determines to move the UE into RRC idle state.

In step 307, the second BS may transmit an RRC release message to the UE. In some embodiments, the RRC release message may be the encapsulated RRC release message received from the first BS. That is, the second BS may directly forward the encapsulated RRC release message to the UE.

The RRC release message may include a suspend indication in the case that the encapsulated RRC release message includes a suspend indication, and the RRC release message may include no suspend indication in the case that the encapsulated RRC release message includes no suspend indication.

In response to receiving the RRC release message including a suspend indication, the UE may be kept in RRC inactive state. In response to receiving the RRC release message including no suspend indication, the UE may be moved into RRC idle state.

In some cases, semi-persistent or aperiodic UL SRS transmission is configured for a UE. In other words, the SRS resources associated with (or configured based on) a current SRS configuration of the UE are semi-persistent or aperiodic. An LMF may request activation or deactivation of the semi-persistent or aperiodic UL-SRS transmission. However, in the case that the UE is configured with a validity area associated with the current SRS configuration for RRC inactive or idle state, the UE does not need to perform SRS reconfiguration when it is within the validity area. Then, when the UE camps or reselects to a new cell that is within the validity area but different from the cell where the UE received the current SRS configuration, the LMF cannot know which cell the UE currently camps in and thus cannot know to which cell the LMF should transmit the corresponding SRS activation or deactivation command if there is no ongoing SDT procedure. The present disclosure provides various methods for SRS activation and deactivation within a validity area (also referred to as SRS validity area) associated with an SRS configuration for RRC inactive or idle state.

FIG. 4 illustrates a flowchart of an exemplary method 400 for SRS activation or deactivation within an SRS validity area according to some embodiments of the present disclosure. The method 400 illustrated in FIG. 4 may be performed by at least three entities, e.g., a UE (e.g., the UE 102), a BS (e.g., the BS 101a), and an LMF (e.g., the LMF 103). Although the method 400 is illustrated in a system level, persons skilled in the art can understand that the method implemented in the three entities can be separately implemented and incorporated in other apparatus with the like functions. It is also contemplated that the method 400 may include additional steps not shown.

Before the steps illustrated in FIG. 4, the UE may receive an SRS configuration for RRC inactive or idle state and a validity area associated with the SRS configuration (e.g., via step 201 or 301) from the BS. The SRS configuration is associated with semi-persistent or aperiodic SRS resources. As shown in FIG. 4, in step 401, the LMF may transmit a positioning activation or deactivation request indicating the BS to activate or deactivate SRS transmission based on the SRS configuration for RRC inactive or idle state via e.g., NRPPa signalling. In step 402, in response to reception of the positioning activation or deactivation request, the BS may transmit a paging (e.g., RAN paging or CN paging) message with a paging cause value indicating to activate or deactivate SRS transmission based on the SRS configuration for RRC inactive or idle state. The UE within the validity area may receive the paging message. In response to the paging message, the UE may activate or deactivate the semi-persistent or aperiodic SRS resources. Specifically, if the paging cause value indicates to activate SRS transmission, the UE activates the semi-persistent or aperiodic SRS resources; if the paging cause value indicates to deactivate SRS transmission, the UE deactivates the semi-persistent or aperiodic SRS resources.

In some embodiments, in the case that the positioning activation or deactivation request indicates the BS to activate SRS transmission, the BS may inform other cells within the validity area to reserve the semi-persistent or aperiodic SRS resources; in the case that the positioning activation or deactivation request indicates the BS to deactivate SRS transmission, the BS may inform other cells within the validity area to release the semi-persistent or aperiodic SRS resources.

In the case that the paging cause value indicates to activate SRS transmission in RRC inactive or idle state, the UE may transmit an RRC resume request for requesting TA configuration to the BS.

It is contemplated that the UE (or a medium access control (MAC) entity of the UE) may transmit SRS only when TA of the configured SRS is valid. The timing to perform TA validation should be considered when the UE moves across the cells within the SRS validity area, to ensure a valid TA before each SRS transmission. A TA configuration may be associated with the SRS configuration in RRC inactive or idle sate, and may be released when the UE reselects or camps to a new cell. When the UE supports validity area associated with SRS configuration for RRC inactive or idle state, the UE maintains the SRS configuration when camps or reselects to a cell within the validity area, and then whether the TA configuration needs to be updated and how does the UE perform TA validation within the validity area associated with the SRS configuration needs to be specified. The present disclosure provides various methods for TA configuration update when the UE roams within an SRS validity area. According to some embodiments of the present disclosure, the UE or the network (e.g., a serving BS of the UE) may initiate the TA configuration update.

In some embodiments, the UE may initiate the TA configuration update by transmitting a TA request for TA configuration update to a BS. In some embodiments, the UE may transmit the TA request periodically. The period for transmitting the TA request may be configured in a TA configuration. In some embodiments, the UE may transmit the TA request when at least one of the following conditions is met:
the UE reselects to a new cell within the validity area associated with a current SRS configuration;
a current TA timer expires or the current TA timer will expire after a predefined or configured period of time;
a first SRS transmission is performed according to a time domain behavior of a current SRS resource configuration or the first SRS transmission will be performed after a predefined or configured period of time according to the time domain behavior of the current SRS resource configuration; or
an SRS configuration update is initiated.

According to some embodiments of the present disclosure, an SRS configuration update may be initiated in at least one of the following cases:
the UE reselects to a new cell which is out of the validity area associated with the current SRS configuration;
the current SRS configuration is invalid (e.g., the current TA timer expires); or
a UL positioning procedure is initiated.

In some embodiments, the UE may transmit the TA request by using at least one of the following:
an MSG1 or MSGA message with a dedicated or shared preamble and on dedicated or shared PRACH resources pre-configured in an SIB message;
an RRC resume request with a cause value indicating to update TA configuration; or
an uplink message for a SDT procedure (e.g., an ongoing SDT procedure or a new SDT procedure).

In response to reception of the TA request, the BS may transmit at least one of a TA command or an updated TA configuration to the UE. For example, when the TA request is transmitted by using an MSG1 or MSGA message, the BS may transmit at least one of a TA command or an updated TA configuration by using a corresponding MSG2 or MSGB message. When the TA request is transmitted by using an RRC resume request, the BS may transmit at least one of a TA command or an updated TA configuration by using a corresponding response to the RRC resume request. When the TA request is transmitted by using an uplink message for a SDT procedure, the BS may transmit at least one of a TA command or an updated TA configuration by using a corresponding downlink message for the SDT procedure.

In response to reception of the at least one of a TA command or an updated TA configuration, the UE may perform at least one of the following: starting or restarting a TA timer; or replacing a stored reference signal received power (RSRP) value of a downlink pathloss reference with a current RSRP value of the downlink pathloss reference. In an embodiment, the received updated TA configuration may include an updated TA timer value or RSRP change threshold.

In some embodiments, the BS may initiate the TA configuration update by transmitting at least one of a TA command or an updated TA configuration. In some embodiments, the BS may transmit at least one of a TA command or an updated TA configuration periodically. The period for transmitting the at least one of a TA command or an updated TA configuration may be configured in a TA configuration. In some embodiments, the BS may transmit a TA command or an updated TA configuration when at least one of the following conditions is met:
the BS receives an indication from an LMF indicating to update TA configuration: in some embodiments, the indication may be a dedicated indication for TA configuration update; in some embodiments, the indication may be a positioning activation or deactivation request indicating the BS to activate SRS transmission associated with the current SRS configuration;
a current TA timer expires or the current TA timer will expire after a predefined or configured period of time; or
a first SRS transmission is performed according to a time domain behavior of a current SRS resource configuration or the first SRS transmission will be performed after a predefined or configured period of time according to the time domain behavior of the current SRS resource configuration.

In some embodiments, the BS may transmit at least one of the TA command or the updated TA configuration by using at least one of an MSG2 message, an MSGB message, a paging (e.g., RAN paging or CN paging) message, or a downlink message (e.g., RRC or MAC CE message) for an ongoing SDT procedure. For example, in the case that a paging message is also used to activate SRS transmission as described above, the paging message with a paging cause value indicating to activate SRS transmission may further carry a TA command or updated TA configuration.

In response to reception of the at least one of the TA command or the updated TA configuration, the UE may perform at least one of the following: starting or restarting a TA timer; or replacing a stored reference signal received power (RSRP) value of a downlink pathloss reference with a current RSRP value of the downlink pathloss reference. In an embodiment, the received updated TA configuration may include an updated TA timer value or RSRP change threshold.

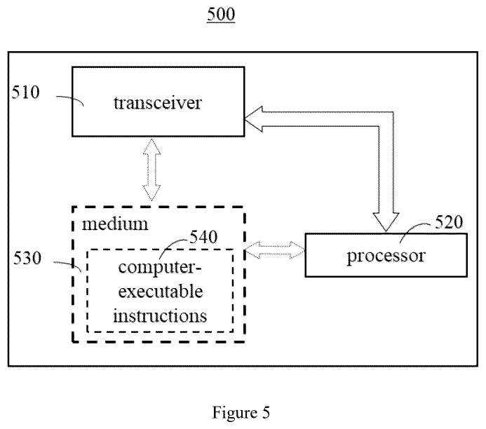

FIG. 5 illustrates a simplified block diagram of an exemplary apparatus 500 according to some embodiments of the present disclosure.

In some embodiments, the apparatus 500 may be or include at least part of a UE (e.g., the UE 102) which is capable of performing any of the operations performed by a UE as described in the present disclosure (e.g., in any of the methods described with respect to FIGS. 2, 3, and 4).

In some embodiments, the apparatus 500 may be or include at least part of a BS (e.g., the BS 101a, or the BS 101b) which is capable of performing any of the operations performed by a BS as described in the present disclosure (e.g., in any of the methods described with respect to FIGS. 2, 3, and 4).

In some embodiments, the apparatus 500 may be or include at least part of an LMF (e.g., the LMF 103) which is capable of performing any of the operations performed by an LMF as described in the present disclosure (e.g., in any of the methods described with respect to FIGS. 2, 3, and 4).

As shown in FIG. 5, the apparatus 500 may include at least a transceiver 510 and a processor 520 coupled to the transceiver 510. In some embodiments, the transceiver 510 may include a transmitter and a receiver integrated together. In some embodiments, the transceiver 510 may include a transmitter and a receiver which are separated from each other. In some embodiments, the transceiver 510 may be a wireless transceiver.

In some embodiments, the apparatus 500 may include a non-transitory computer-readable medium 530 with computer-executable instructions 540 stored thereon. The non-transitory computer-readable medium 530 may be coupled to the processor 520 and the transceiver 510, and the computer-executable instructions 540 may be configured to be executable by the processor 520. In some embodiments, the transceiver 510, the non-transitory computer-readable medium 530, and the processor 520 may be coupled to each other via one or more local buses.

Although in FIG. 5, elements such as the transceiver 510, the non-transitory computer-readable medium 530, and the processor 520 are described in the singular, the plural is contemplated unless limitation to the singular is explicitly stated. In certain embodiments of the present disclosure, the apparatus 500 may further include other components for actual usage.

In various example embodiments, the processor 520 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, the processor 520 may also include at least one other circuitry or element not shown in FIG. 5.

In various example embodiments, the non-transitory computer-readable medium 530 may include at least one storage medium in various forms, such as a volatile memory and/or a non-volatile memory. The volatile memory may include, but is not limited to, for example, an RAM, a cache, and so on. The non-volatile memory may include, but is not limited to, for example, an ROM, a hard disk, a flash memory, and so on. Further, the non-transitory computer-readable medium 530 may include, but is not limited to, an electric, a magnetic, an optical, an electromagnetic, an infrared, or a semiconductor system, apparatus, or device or any combination of the above.

Further, in various example embodiments, the apparatus 500 may also include at least one other circuitry, element, and interface, for example antenna element, and the like.

According to some embodiments, the apparatus 500 is a UE. The transceiver 510 and the processor 520 may be configured to perform operations in any methods described above which are performed by a UE. For example, the processor 520 may be configured to: receive, with the transceiver 510 and from a first BS, an SRS configuration for RRC inactive or idle state and a first validity area associated with the first SRS configuration; transmit, with the transceiver 510 and to a second BS, an RRC resume request, wherein the RRC resume request includes an I-RNTI allocated by the first BS and a cause value indicating to update SRS configuration and associated validity area; and receive, with the transceiver 510 and from the second BS, an RRC release message in response to the RRC resume request.

According to some embodiments, the apparatus 500 is a first BS. The transceiver 510 and the processor 520 may be configured to perform operations in any methods described above which are performed by a BS. For example, the processor 520 may be configured to transmit, with the transceiver 510 and to a UE, a first SRS configuration for RRC inactive or idle state and a first validity area associated with the first SRS configuration; receive, with the transceiver 510 and from a second BS, a retrieve context request for retrieving a context of the UE, wherein the retrieve context request includes a cause value indicating to update SRS configuration and associated validity area of the UE; and transmit, with the transceiver 510 and to the second BS, (1) a retrieve context response with the context of the UE in the case that it is determined to update the first SRS configuration and the first validity area, or (2) a retrieve context failure message including an encapsulated RRC release message in the case that it is determined not to update the first SRS configuration and the first validity area.

According to some embodiments, the apparatus 500 is a second BS. The transceiver 510 and the processor 520 may be configured to perform operations in any methods described above which are performed by a BS. For example, the processor 520 may be configured to receive, with the transceiver 510 and from a UE, an RRC resume request including an I-RNTI allocated by a first BS and a cause value indicating to update SRS configuration and associated validity area; transmit, with the transceiver 510 and to the first BS, a retrieve context request for retrieving a context of the UE in response to receiving the RRC resume request, wherein the retrieve context request includes a cause value indicating to update SRS configuration and associated validity area; receive, with the transceiver 510 and from the first BS, (1) a retrieve context response with the context of the UE or (2) a retrieve context failure message including an encapsulated RRC release message; and transmit, with the transceiver 510 and to the UE, an RRC release message based on the received retrieve context response or retrieve context failure message.

According to some embodiments, the apparatus 500 is an LMF. The transceiver 510 and the processor 520 may be configured to perform operations in any methods described above which are performed by an LMF. For example, the processor 520 may be configured to receive, with the transceiver 510 and from a first BS, an SRS validity area update indication including an identity of a second BS, wherein the SRS validity area update indication indicates updating a first validity area associated with a first SRS configuration for RRC inactive or idle state for a UE; and transmit, with the transceiver 510, an SRS validity area update response to the first BS in response to the SRS validity area update indication, wherein the SRS validity area update response indicates that the LMF acknowledges or rejects to update the first SRS configuration and the first validity area.

In various example embodiments, the circuitry, parts, elements, and interfaces in exemplary apparatus, including processor and non-transitory computer-readable medium, may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.” In this disclosure, relational terms such as “first,” “second,” and the like may be used solely to distinguish one entity or action from another entity or action without necessarily requiring or implying any actual such relationship or order between such entities or actions.

1. A user equipment (UE) for wireless communication, comprising:
at least one memory; and
at least one processor coupled with the at least one memory and configured to cause the UE to:
receive, from a first base station (BS), a first sounding reference signal (SRS) configuration for a radio resource control (RRC) inactive or idle state and a first validity area associated with the first SRS configuration;
transmit an RRC resume request to a second BS, wherein the RRC resume request includes a cause value indicating to update the first SRS configuration and associated first validity area; and
receive, from the second BS, an RRC release message.

2. The UE of claim 1, wherein the at least one processor is further configured to cause the UE to receive, from the second BS, a second SRS configuration for the RRC inactive or idle state and a second validity area associated with the second SRS configuration.

3. The UE of claim 1, wherein the first SRS configuration is associated with semi-persistent or aperiodic SRS resources, and wherein the at least one processor is further configured to cause the UE to:
receive, from the first BS, a paging message; and
in response to the paging message, activate or deactivate the semi-persistent or aperiodic SRS resources.

4. The UE of claim 1, wherein the at least one processor is further configured to cause the UE to transmit a timing advance (TA) request for a TA configuration update periodically or when at least one of the following conditions is met:
the UE reselects to a new cell within the first validity area;
a current TA timer expires or the current TA timer is to expire after a predefined or configured period of time;
a first SRS transmission is performed according to a time domain behavior of a current SRS resource configuration or the first SRS transmission is to be performed after a predefined or configured period of time according to the time domain behavior of the current SRS resource configuration; or
an SRS configuration update is initiated.

5. The UE of claim 4, wherein the at least one processor is configured to cause the UE to transmit the TA request by using at least one of the following:
an MSG1 or MSGA message with a dedicated or shared preamble and on dedicated or shared physical random access channel (PRACH) resources pre-configured in a system information block (SIB) message;
an RRC resume request with a cause value indicating to update the TA configuration; or
an uplink message for a small data transmission (SDT) procedure.

6. The UE of claim 1, wherein the at least one processor is further configured to cause the UE to receive at least one of a TA command or an updated TA configuration by using at least one of an MSG2 or MSGB message, a paging message, or a downlink message for an ongoing small data transmission (SDT) procedure.

7. A first base station (BS) for wireless communication, comprising:
at least one memory; and
at least one processor coupled with the at least one memory and configured to cause the first BS to:
transmit, to a user equipment (UE), a first sounding reference signal (SRS) configuration for a radio resource control (RRC) inactive or idle state and a first validity area associated with the first SRS configuration;
receive, from a second BS, a retrieve context request for retrieving a context of the UE, wherein the retrieve context request includes a cause value indicating to update the first SRS configuration and the associated validity area of the UE; and
transmit, to the second BS, a retrieve context response with the context of the UE upon determining to update the first SRS configuration and the first validity area.

8. The first BS of claim 7, wherein the at least one processor is further configured to cause the first BS to:
transmit, to a location management function (LMF), an SRS validity area update indication including an identity of the second BS in response to receiving the retrieve context request.

9. The first BS of claim 8, wherein the at least one processor is further configured to cause the first BS to:
receive, from the LMF, a first release indication to release SRS resources associated with the first SRS configuration.

10. The first BS of claim 8, wherein the at least one processor is further configured to cause the first BS to transmit, to other cells within the first validity area, a release indication to indicate the other cells to release SRS resources associated with the first SRS configuration.

11. The first BS of claim 7, wherein the first SRS configuration is associated with semi-persistent or aperiodic SRS resources, and the at least one processor is further configured to cause the first BS to:
receive, from a location management function (LMF), a positioning activation or deactivation request indicating to the first BS to activate or deactivate SRS transmission based on the first SRS configuration; and
in response to receiving the positioning activation or deactivation request, transmit, to the UE, a paging message with a paging cause value indicating to activate or deactivate SRS transmission based on the first SRS configuration.

12. The first BS of claim 11, wherein the at least one processor is further configured to cause the first BS to:
inform other cells within the first validity area to reserve the semi-persistent or aperiodic SRS resources when the positioning activation or deactivation request indicates the first BS to activate SRS transmission; or
inform other cells within the first validity area to release the semi-persistent or aperiodic SRS resources when the positioning activation or deactivation request indicates the first BS to deactivate SRS transmission.

13. The first BS of claim 7, wherein the at least one processor is further configured to cause the first BS to transmit, to the UE, at least one of a timing advance (TA) command or an updated TA configuration periodically or when at least one of the following conditions is met:
the first BS receives an indication from a location management function (LMF) indicating to update the TA configuration;
a current TA timer expires or the current TA timer is to expire after a predefined or configured period of time; or
a first SRS transmission is performed according to a time domain behavior of a current SRS resource configuration or the first SRS transmission is to be performed after a predefined or configured period of time according to the time domain behavior of the current SRS resource configuration.

14. A location management function (LMF) for wireless communication, comprising:
at least one memory; and
at least one processor coupled with the at least one memory and configured to cause the LMF to:
receive, from a first base station (BS), a sounding reference signal (SRS) validity area update indication including an identity of a second BS, wherein the SRS validity area update indication indicates updating a first validity area associated with a first SRS configuration for a radio resource control (RRC) inactive or idle state for a user equipment (UE); and
transmit, with the transceiver, an SRS validity area update response to the first BS in response to the SRS validity area update indication, wherein the SRS validity area update response indicates that the LMF acknowledges or rejects to update the first SRS configuration and the first validity area.

15. The LMF of claim 14, wherein:
when the LMF acknowledges to update the first SRS configuration and the first validity area, the at least one processor is further configured to cause the LMF to transmit uplink (UL) SRS transmission characteristics information to the second BS.

16. The UE of claim 4, wherein the at least one processor is configured to cause the UE to transmit an RRC resume request for requesting a TA configuration when a paging cause value indicates to activate the first SRS transmission.

17. A method performed by a user equipment (UE), the method comprising:
receiving, from a first base station (BS), a first sounding reference signal (SRS) configuration for a radio resource control (RRC) inactive or idle state and a first validity area associated with the first SRS configuration;
transmitting an RRC resume request to a second BS, wherein the RRC resume request includes a cause value indicating to update the first SRS configuration and associated first validity area; and
receiving, from the second BS, an RRC release message.

18. The method of claim 17, wherein the first SRS configuration is associated with semi-persistent or aperiodic SRS resources, the method further comprising:
receiving, from the first BS, a paging message; and
in response to the paging message, activating or deactivating the semi-persistent or aperiodic SRS resources.

19. The method of claim 16, further comprising: transmitting a timing advance (TA) request for a TA configuration update periodically or when at least one of the following conditions is met:
the UE reselects to a new cell within the first validity area;
a current TA timer expires or the current TA timer is to expire after a predefined or configured period of time;
a first SRS transmission is performed according to a time domain behavior of a current SRS resource configuration or the first SRS transmission is to be performed after a predefined or configured period of time according to the time domain behavior of the current SRS resource configuration; or
an SRS configuration update is initiated.

20. The method of claim 19, further comprising: transmitting an RRC resume request for requesting a TA configuration when a paging cause value indicates to activate the first SRS transmission.
